(19) United States
(12) Patent Application Publication
(10) Pub. No.: US 2008/0016607 A1
(43) Pub. Date: Jan. 24, 2008

(54) Liquid shield for use in connection with a toilet seat

(76) Inventor: Marc A. Cottage, Smithtown, NY (US)

Correspondence Address: Marc A. Cottage, 10 Angelica Court, Smithtown, NY, 17787, US

(21) Appl. No.: 11/489,081

(22) Filed: Jul. 19, 2006

(51) Int. Cl. E03D 9/00; F15D 1/00

(52) U.S. Cl. 4/300.3

(57) ABSTRACT

Disclosed is a shield configured to block liquid flow from a space defined between a front of a toilet seat and a toilet rim. The shield is configured to direct liquid impinging upon the shield into the toilet. In one version, the shield may extend downward from a bottom front area of the toilet seat towards and, preferably, below the rim of the toilet. Alternatively, the shield may extend upward from the rim of the toilet towards and, preferably, even with or above the space defined between the front of the toilet seat and the rim of the toilet.

### FIELD OF THE INVENTION

The present invention relates to a shield for use in connection with a toilet or toilet seat. In particular, the invention is a shield that blocks a flow of liquids, such as urine, from a space defined between a front of a toilet seat and a toilet rim.

### DISCUSSION OF RELATED ART

FIG. 1 is a side view of a conventional toilet 100 having a conventional toilet seat 102. FIG. 2 is a front view of the conventional toilet 100 and the conventional toilet seat 102. The toilet has a rim 104. As seen in both FIG. 1 and FIG. 2, a toilet seat spacer 106 defines a space 108 between the bottom 110 of the toilet seat 102 and the top of the toilet rim 104.

It is possible that a seated male, particularly a young boy, may urinate in a way that urine will pass through the space 108 defined between the bottom 110 of the toilet seat 102 and the top of the toilet rim 104. Urine may pass through the space 108 at or near the front of the toilet seat 102 and the toilet rim 104. This urine will be outside of the toilet, thus creating an undesirable, unsanitary condition that requires cleaning.

It is desirable to provide a device that will block the flow of liquid, such as urine, from passing between the space between the bottom 110 of the toilet seat 102 and the toilet rim 104.

### SUMMARY OF THE INVENTION

The invention is a shield configured to block liquid flow from a space defined between a front of a toilet seat and a toilet rim. The shield is configured to direct liquid impinging upon the shield into the toilet. Preferably, the shield may extend downward from a bottom front area of the toilet seat towards and, preferably, below the rim of the toilet. Alternatively, the shield may extend upward from the rim of the toilet towards and, preferably, even with or above the space defined between the front of the toilet seat and the rim of the toilet.

In a first embodiment of the present invention, the shield is integrally formed with the toilet seat. Preferably, the shield is connected to a bottom front portion of the toilet seat and extends downward. The shield is configured to block a flow of liquid from the space defined below the front area bottom surface and the rim of the toilet. Preferably, the shield extends below the rim of the toilet, thus directing the liquid impinging upon the shield into the toilet.

In a second embodiment of the present invention, the shield is for connection to a toilet seat. The shield is configured to block the flow of liquid from the space below the front bottom surface of the toilet seat. The shield may be connected to the toilet seat by any number of connectors, such as screws, adhesives, etc.

In a third embodiment of the present invention, the shield may be selectively connectible to and/or removable from the toilet seat. The clip is connectable to the front bottom side of a toilet seat. The clip may be either permanently or removably connected to the toilet seat. The shield may be held in place by the clip so that the shield may be removed, for example, for replacement or cleaning.

In a fourth embodiment of the present invention, the shield is removably connected to the toilet seat by a connector configured to engage at least a portion of the toilet seat.

In a fifth embodiment of the invention, the shield is for connection to a rim of a toilet. The shield is configured to block a flow of liquid from a space above the rim of the toilet. The shield may extend upward from the rim of the toilet towards and, preferably, even with or above the space defined between the front of the toilet seat and the rim of the toilet.

At least the third, fourth, and fifth embodiments may be used in combination with toilet bowl cleaners, fragrances, and/or fresheners.

These and other features of the invention will be more clearly understood and better described if the following detailed description is read in conjunction with the appended drawings. In the drawings, like numerals refer to like parts throughout.

### BRIEF DESCRIPTION OF THE DRAWINGS

FIG. 1 is side view of a conventional toilet, toilet seat, and lid.

FIG. 2 is a front view of a conventional toilet, toilet seat, and lid.

FIG. 3 is a side view of a toilet, toilet seat, lid, and a shield according to an embodiment of the present invention.

FIG. 4 is a front view of a toilet, toilet seat, lid, and a shield according to an embodiment of the present invention.

FIG. 5 is a side view of a toilet seat having a shield according to an embodiment of the present invention.

FIG. 6 is a front view of a toilet seat having a shield according to an embodiment of the present invention.

FIG. 7 is a bottom view of a toilet seat having a shield according to an embodiment of the present invention.

FIG. 8 is front view of a shield according to an embodiment of the present invention.

FIG. 9 is a bottom view of a shield according to an embodiment of the present invention.

FIG. 10 is a side view of a shield according to an embodiment of the present invention.

FIG. 11 is a rear view of a shield according to an embodiment of the present invention having screws as a connector.

FIG. 12 is a rear view of a shield according to an embodiment of the present invention having double-sided tape as a connector.

FIG. 13 is a side view of a toilet seat having a shield according to another embodiment of the present invention.

FIG. 14 is a partial bottom view of a toilet seat having a shield according to an embodiment of the present invention.

FIG. 15 is a side view of a clip for connecting a shield to a toilet seat according to an embodiment of the present invention.

FIG. 16 is a bottom view of a clip for connecting a shield to a toilet seat according to an embodiment of the present invention.

FIG. 17 is a side view of a toilet seat having a shield according to another embodiment of the present invention.

FIG. 18 is a partial bottom view of a toilet seat having a shield according to an embodiment of the present invention.

FIG. 19 is a side view of a shield according to an embodiment of the present invention.

FIG. 20 is a cutaway partial side view of a toilet and a shield according to another embodiment of the present invention.

FIG. 21 is a bottom view of a shield according to an embodiment of the present invention.

FIG. 22 is a side view of a shield according to an embodiment of the present invention.

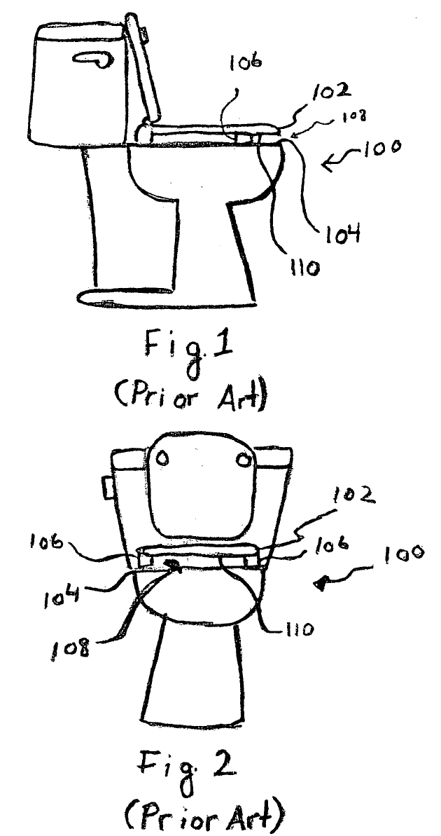

### DETAILED DESCRIPTION OF PREFERRED EMBODIMENTS OF THE INVENTION

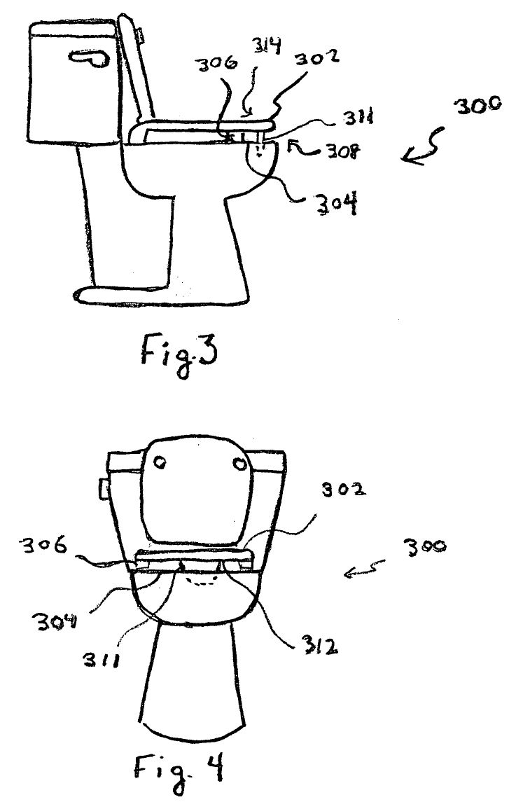

FIGS. 3 and 4 are a side view and a front view, respectively, of a toilet 300 having a toilet seat 302, a toilet rim 304, a toilet seat spacer 306, and a shield 311 according to an embodiment of the present invention. The dashed lines illustrate the portion of the shield 311 that extends into the toilet. As seen in FIGS. 3 and 4, the shield 311 according to this embodiment of the present invention is connected to a front bottom portion 312 or front inner side 314 of the toilet seat 302 and extends downwards to block a flow of liquid, such as urine, from a space 308 between the toilet seat 302 and the toilet rim 304. The shield 311 is configured to direct liquid impinging upon the shield 311 into the toilet 300. Thus, the shield 311 prevents the problem of liquid, such as urine, flowing through the space and outside the toilet 300 and creating an unsanitary condition.

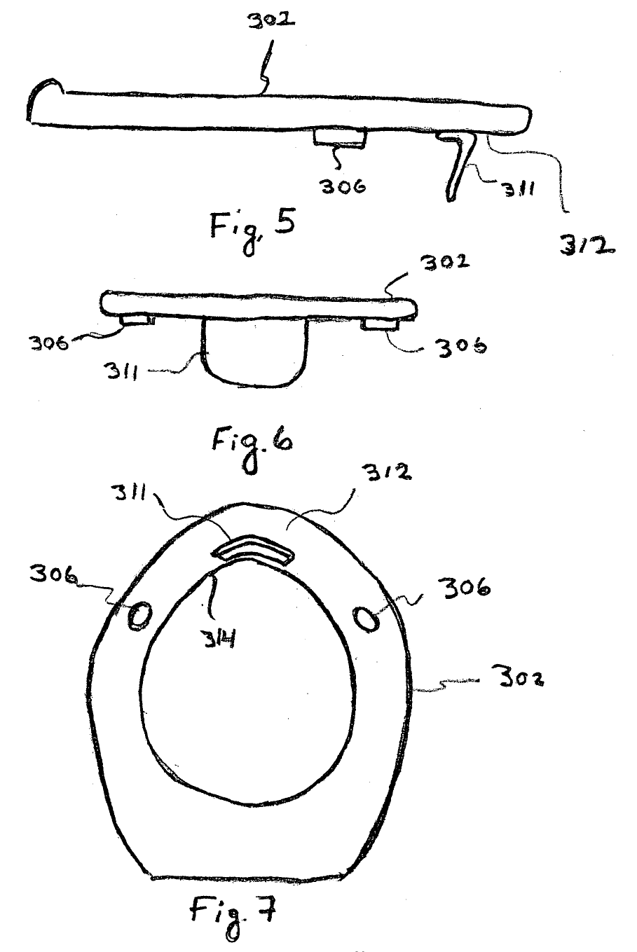

FIGS. 5, 6, and 7 further illustrate the toilet seat 302 having the toilet seat spacer 306 and including the shield 311 according to an embodiment of the invention. As best seen in FIGS. 5 and 7, the shield 311 may be shaped to conform to the shape or contour of the toilet seat 302 and/or toilet rim 304 (seen in FIGS. 3 and 4). In the illustrative example of FIG. 5, the shield 311 angles slightly inwardly from a location at or near the front bottom portion 312 or front inner portion 314 of the toilet seat to a location at or near the toilet rim 304. In the illustrative example of FIG. 7, the shield 311 is connected to a front bottom portion of the 312 of the toilet seat 302 and curves to conform to the shape of the toilet seat front inner portion 314, and possibly to conform to the shape of the toilet rim 304.

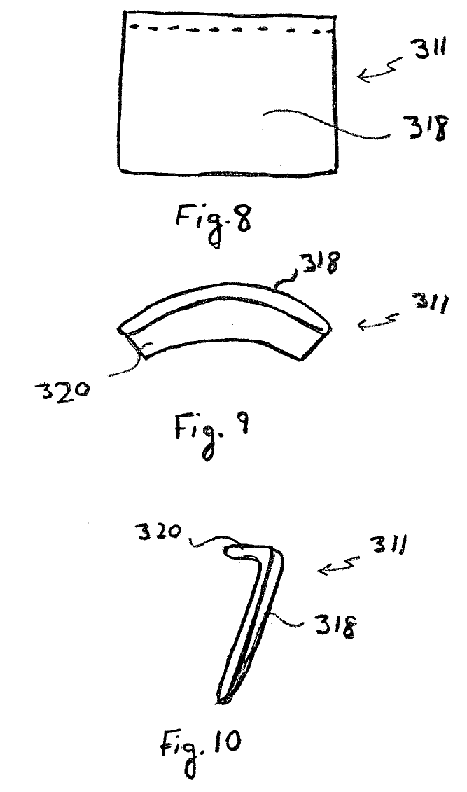

FIGS. 8, 9, and 10 further illustrate the shield 311 according to an embodiment of the invention. FIG. 8 is a front view of a shield according to an embodiment of the invention. A front portion 318 of the shield 311 is seen. The dashed lines indicate the optional attachment portion 320 located behind the front portion 318 of the shield 311. FIG. 9 is a bottom view of a shield 311 according to an embodiment of the invention. The optional attachment portion 320 is seen. In this embodiment, the attachment portion 320 extends from the front portion 318, preferably at an angle of about between 45° and 90°. In the illustrative example of FIG. 9, the front portion 318 and the attachment portion 320 are curved. FIG. 10 is a side view of the shield 311 according to an embodiment of the invention. FIG. 10 shows the front portion 318 and the optional attachment portion 320. In the illustrative example of FIG. 10, the front portion 318 of the shield 311 angles inwardly as described above in connection with FIG. 5.

In a first preferred embodiment of the present invention, as best seen in FIGS. 5, 6, and 7, the shield 311 may be fabricated integrally with the toilet seat 302. In this preferred embodiment, the shield may be made of any suitable material that will block liquids, such as urine, from passing through the shield 311, such as the material that the toilet seat 302 is made, or other material. The toilet seat 302 and integral shield 311 may be made of vinyl, plastic, wood, metal, or any other suitable material and may be made using any suitable manufacturing method, such as well-known toilet seat manufacturing methods. Alternatively, the shield 311 may be connected to the toilet seat 302 using well-known techniques, such as well-known techniques for connecting a toilet seat spacer 306 (as seen, for example, in FIGS. 3 through 7) to a toilet seat 302.

In a second preferred embodiment of the present invention, the shield is connectable to the toilet seat 302. Any suitable connector may be used to connect the shield to the toilet seat. One example of a shield according to this embodiment of the present invention is illustrated in FIG. 11. As seen in FIG. 11, the shield 1101 has a front portion (the back of which is seen in FIG. 11) and an attachment portion 1120. The attachment portion 1120 may extend from the front portion 1118, preferably at an angle between about 45° to 90°. The shield 1101 is connectable to, for example, the front bottom portion 312 or front inner side 314 of a toilet seat 302 (as seen in FIGS. 5, 6, and 7). The connection may be made using connecting means such as screws 1103 or other suitable connector, such as nails, bolts, molly bolts, rivets, grommets, glue, epoxy, and the like. The connector may extend through the attachment portion 1120.

Another example of a shield according to the present invention is illustrated in FIG. 12. As seen in FIG. 12, the shield 1201 may be substantially similar to the shield 1101 of FIG. 11, except that it is connectable to a toilet seat 302 using connecting means such as double-sided tape 1203, other adhesive, hook and loop fasteners (Velcro), or other suitable means.

A shield 1101, 1201 according to this second preferred embodiment may be made of any suitable material, such as plastic, polystyrene, Plexiglas, vinyl, wood, metal, and the like; and may be manufactured using any suitable manufacturing method, such as injection molding, extrusion, plastic forming, or other well-known manufacturing techniques. An actual reduction to practice of this embodiment is made of Plexiglas and formed using a Plexiglas bender. The material selected should preferably be able to withstand repeated exposures to urine or other liquid without losing its ability to block liquid flow through a space defined between a front of the toilet and the toilet rim.

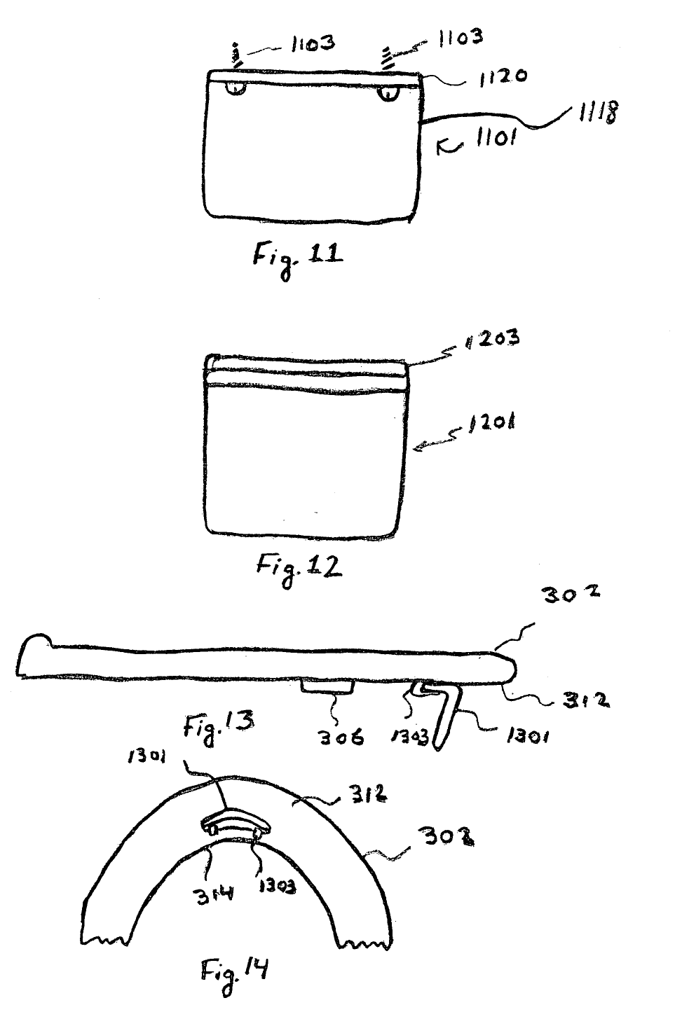

In a third preferred embodiment of the present invention, the shield may be selectively connectable to and/or removable from the toilet seat. The shield may be, for example, removed or replaced for cleaning or disposed of in favor of a replacement shield. One example of a shield according to this embodiment of the present invention is illustrated in FIGS. 13 and 14. As seen in FIGS. 13 and 14, the shield 1301 is held by a connecting means such as a clip 1303, which clip 1303 is connected to the front bottom portion 312 or front inner side 314 of the toilet seat 302. In this example of this embodiment, the shield 1301 may slide into an appropriate position and held in place by the clip 1303. The shield 1301 may be, for example, substantially similar to the shields discussed above in connection with FIGS. 3 through 12. However, because one optional purpose of the shield 1301 according to this embodiment is to be replaceable, the shield 1301 may be made of less sturdy materials, provided that these materials are capable of blocking liquids from passing through for the amount of time that the shield 1301 is expected or intended to be used. As a result, in addition to the materials mentioned above, inexpensive materials may be suitable for use, such as thick paper stock, cardboard, or other such material, particularly if the material is treated to be resistant to liquid saturation.

The clip 1303, as discussed in more detail below, may use elastic, spring, or other forces to hold the shield 1301 in place. The clip 1303 may have one or more arms 1305 configured to hold the shield 1301 in place. The clip may also include a clip attachment portion 1321 for facilitating connection of the clip 1303 to the toilet seat 302. The clip 1303 may be connected to the toilet seat 302 by any suitable method, such as the methods described above in connection with FIGS. 11 and 12.

FIGS. 15 and 16 illustrate a clip 1303 for use in connection with the shield 1301 according to this third embodiment of the present invention. FIG. 15 is a side view of a clip 1303. The clip 1303 may be configured so that it uses elastic, spring, or other forces to engage with the shield 1301. Alternatively, other suitable structures may be used for connecting the shield 1301 with the clip 1303, such as an indent/detent connection, or other well-known structure.

The clip 1303 may be made of any suitable material, such as plastics, metals, or other well-known materials. Preferably, the clip is configured to have a displaceable clamping force sufficient to hold the shield 1301 securely in position, yet should yield to displacement force so that the shield 1301 may be inserted or removed when desired.

In a fourth preferred embodiment of the present invention, the shield is removably connected to the toilet seat by a connector configured to engage at least a portion of the toilet seat. One example of a shield according to this embodiment of the invention is illustrated in FIGS. 17, 18, and 19. In this embodiment, the shield may be used temporarily in connection with a toilet seat for short-term use, and/or may be removed for cleaning or replacement in favor of a new shield.

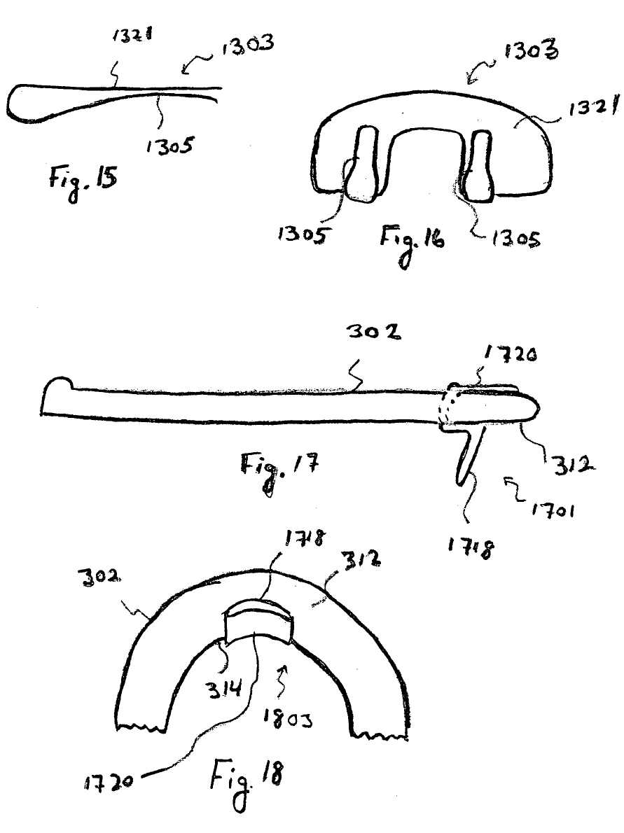

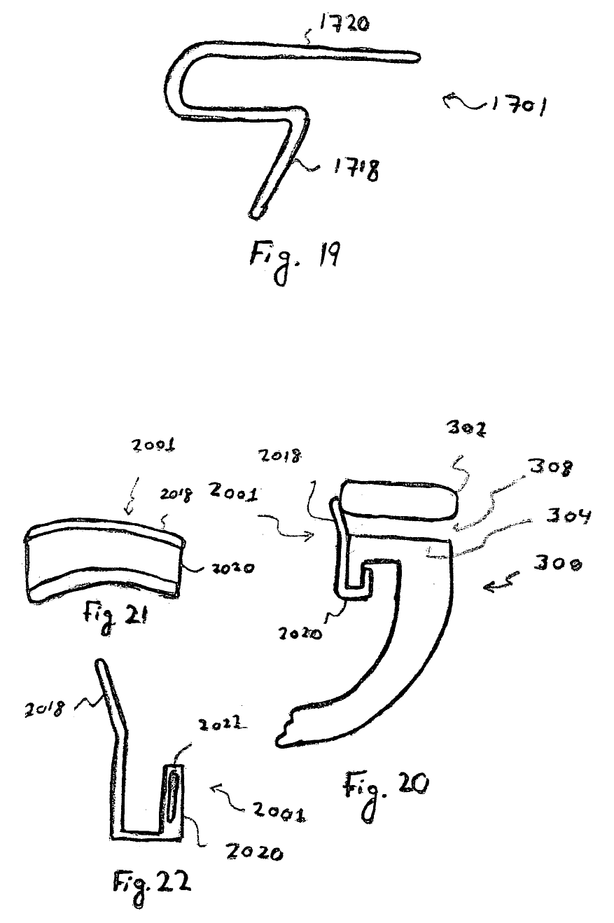

FIG. 17 is a side view of a toilet seat 302 and a shield 1701 having a shield front portion 1718 and a shield attachment portion 1720. The shield attachment portion 1720 may be u-shaped to securely engage with the toilet seat 302. The dashed lines indicate the part of the shield attachment portion 1720 that extends around the inner opening (1803 in FIG. 18) in the toilet seat 302. FIG. 18 is a bottom view of a toilet seat 302 having connected to it a shield 1701 according to the fourth embodiment of the present invention. FIG. 19 is a side view of a shield 1701 according to the fourth embodiment of the present invention.

As seen in FIGS. 17, 18, and 19, the shield 1701 is connected to the toilet seat 302 by the shield attachment portion 1720. The shield attachment portion 1720 preferably wraps around at least a portion of the toilet seat 302 to hold the shield 1701 in an appropriate position. The shield attachment portion 1720 may be configured to have a clamping force to connect to the toilet seat 302. The shield front portion 1718 and shield attachment portion 1720 may be made of any suitable material and by any suitable manufacturing method, such as those described above. In addition, because one optional purpose of a shield 1701 according to this embodiment is to be temporary or replaceable, the shield front portion 1718 (and possibly the shield attachment portion 1720) may be made of less sturdy materials, provided that these materials are capable of blocking liquids from passing through for the amount of time that the shield 1701 is expected or intended to be used. As a result, in addition to the materials mentioned above, inexpensive materials may be suitable for use, such as thick paper stock, cardboard, or other such material, particularly if the material is treated to be resistant to liquid saturation.

In a fifth embodiment of the invention, the shield is for connection to a toilet rim 304. The shield is configured to block a flow of liquid from a space above the rim of the toilet. The shield may extend upward from the rim of the toilet towards and, preferably, even with or above the space defined between the front of the toilet seat and the rim of the toilet. One example of a shield according to this embodiment of the invention is illustrated in FIGS. 20, 21, and 22.

FIG. 20 is a cross-sectional view of a toilet 300 having a rim 304, a toilet seat 302, and a shield 2001 according to a preferred embodiment of the present invention. As seen in FIG. 20, the shield 2001 includes a shield front portion 2018 and a shield attachment portion 2020. The shield is configured for connection to the rim 304 by the shield attachment portion 2020 that engages the toilet rim 304, preferably by wrapping around the toilet rim 304. As seen in FIG. 20, the shield 2001 extends upward from the rim 304 towards and, preferably, even with or above the space 308 defined between the front of the toilet seat 302 and the toilet rim 308.

The shield attachment portion 2020 may be configured to have a clamping force to connect to the toilet rim 304. The shield front portion 2018 and the shield connection portion 2020 may be made of any suitable material and by any suitable manufacturing method, such as those described above. In addition, because one optional purpose of a shield 2001 according to this embodiment is to be temporary or replaceable, the shield front portion 2018 (and possibly the shield attachment portion 2020) may be made of less sturdy materials, provided that these materials are capable of blocking liquids from passing through for the amount of time that the shield 2001 is expected or intended to be used. As a result, in addition to the materials mentioned above, inexpensive materials may be suitable for use, such as thick paper stock, cardboard, or other such material, particularly if the material is treated to be resistant to liquid saturation.

Optionally, the shields according to the above embodiments may be used in combination with toilet bowl cleaners, fragrances, and/or fresheners. FIG. 22 illustrates an optional cleaner, fragrance, and/or freshener 2022.

Many modifications and other embodiments of-the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

I claim:

1. An apparatus comprising a shield configured to block liquid flow from a space defined between a front of a toilet seat and a rim of a toilet.

2. The apparatus of claim 1, wherein the shield is further configured to direct liquid impinging upon said shield into the toilet.

3. The apparatus of claim 1, wherein the shield is shaped to conform to the shape of the toilet seat.

4. The apparatus of claim 1, wherein the shield is shaped to conform to the shape of the toilet rim.

5. The apparatus of claim 1, wherein the shield is angled inwardly from a location at a bottom of the toilet seat towards a location at the toilet rim.

6. The apparatus of claim 5, wherein the angle is range between 45° and 90°.

7. A toilet seat, said toilet seat comprising:
a. a front area bottom surface;
b. a shield connected to the front area bottom shield and extending downward, the shield configured to block a flow of liquid from a space defined below the front area bottom surface.

8. The toilet seat of claim 7, wherein the shield is further configured to extend below a rim of a toilet.

9. The toilet seat of claim 8, wherein the shield is further configured to direct liquid impinging on said shield into the toilet.

10. A shield for connection to a toilet seat, said shield configured to block a flow of liquid from a space below a front area bottom surface of the toilet seat.

11. The shield of claim 10 further configured to extend below a rim of the toilet.

12. The shield of claim 10, wherein the shield is further configured to direct liquid impinging on said shield into the toilet.

13. The shield of claim 10, wherein the shield comprises a front portion and an attachment portion, the attachment portion configured to connect to the toilet seat.

14. The shield of claim 13, wherein attachment portion extend from the shield portion at an angle in arrange between 45° and 90°.

15. The shield of claim 10 further comprising a connector configured to connect the shield to the toilet seat.

16. The shield of claim 15, wherein the connector is a clip.

17. The shield of claim 15, wherein the connector is an adhesive.

18. The shield of claim 15, wherein the connector is configured to engage at least a portion of the toilet seat.

19. A shield for connection to a rim of a toilet, said shield configured to block a flow of liquid from a space above the rim of the toilet.

20. The shield of claim 19, wherein the shield further comprises a connector configured to connect the shield to the rim of the toilet.
